(19) United States
(12) Patent Application Publication
(10) Pub. No.: US 2017/0262124 A1
(43) Pub. Date: Sep. 14, 2017

(54) TOUCH PANEL DEVICE

(71) Applicant: Sharp Kabushiki Kaisha, Osaka (JP)

(72) Inventors: Toshimitsu GOTOH, Osaka (JP); Shinichi MIYAZAKI, Osaka (JP); Hiroki MAKINO, Osaka (JP)

(73) Assignee: Sharp Kabushiki Kaisha, Osaka (JP)

(21) Appl. No.: 15/511,397

(22) PCT Filed: Aug. 31, 2015
(86) PCT No.: PCT/JP2015/074709

§ 371 Date: Mar. 15, 2017

(30) Foreign Application Priority Data
Sep. 16, 2014 (JP) 2014-187646

(51) Int. Cl. G06F 3/041; G02F 1/1333; G02F 1/1335; G06F 3/044

(52) U.S. Cl. CPC G06F 3/0416; G06F 3/044; G06F 3/0412; G02F 1/13338; G02F 1/133514; G02F 2202/28; G02F 1/136286

(57) ABSTRACT

The present invention provides a touch panel device that utilizes a touch panel driving process that suitably prevents discoloration of an on-cell touch panel. A touch panel-equipped display device includes a touch panel and a touch panel controller. In the touch panel, drive electrodes and sense electrodes are formed in the same layer. The touch panel controller generates drive signals in a manner that keeps an integrated value of differences in electric potential between the drive electrodes and the sense electrodes less than a prescribed value during prescribed periods in which the touch panel is driven.

### TECHNICAL FIELD

The present invention relates to a technology for use in a display device or the like that is equipped with a touch panel device or a touch panel.

### BACKGROUND ART

Touch panel devices can be used to input information to another device by touching the surface of the touch panel with a finger or a pen. In recent years, capacitive touch panel devices with increasingly good detection sensitivity and usability have seen use in various devices. Projected capacitive touch panel devices, which can precisely detect the coordinates at which the touch panel surface is touched by a finger or a pen, have seen particularly widespread use (see Patent Document 1 (WO 2013/065272), for example).

Capacitive touch panel devices include a plurality of drive lines and a plurality of sense lines. A plurality of X-axis direction sense electrodes are formed on each drive line, and a plurality of Y-axis direction sense electrodes are formed on each sense line. Capacitive touch panel devices output drive pulse signals to the drive lines in order and then scan for changes in the electric fields (changes in capacitance) between the X-axis direction sense electrodes and the Y-axis direction sense electrodes. In other words, capacitive touch panel devices detect the coordinates at which the touch panel surface is touched by a finger or a pen by detecting, via the sense lines, signals corresponding to changes in the electric fields (changes in capacitance) between the X-axis direction sense electrodes and the Y-axis direction sense electrodes.

In the touch panels used in capacitive touch panel devices, the X-axis direction sense electrodes and the X-axis direction sense electrodes are formed in different layers. Furthermore, in the touch panels used in capacitive touch panel devices, an insulating layer is formed between the layer in which the X-axis direction sense electrodes are formed and the layer in which the Y-axis direction sense electrodes are formed.

In capacitive touch panel devices, drive signals are used to drive the touch panel. Moreover, a prescribed voltage (bias voltage) is applied to the sense lines so that the Y-axis direction sense electrodes take a prescribed electric potential at a prescribed time.

FIG. 9 is a signal waveform diagram illustrating examples of a drive signal Tx1 and a sense signal Rx1.

In FIG. 9, the drive signal Tx1 is a signal that is applied via a first drive line in order to drive an X-axis direction sense electrode that is connected to the first drive line. Moreover, the sense signal Rx1 is a signal that is used to detect, via the sense lines, signals corresponding to changes in the electric fields (changes in capacitance) between the X-axis direction sense electrodes and the Y-axis direction sense electrodes, and while a prescribed drive line is being driven, the sense signal Rx1 is biased to a prescribed electric potential Vr (Vr=1.65V, for example).

In the touch panel device, these drive signals create electric fields on the touch panel surface, and a receiver receives, via the sense lines, received signals (sense signals) that correspond to changes in the electric fields that are caused when the touch panel surface is touched. The touch panel device then identifies (detects) the touch position on the touch panel surface on the basis of the signals received by the receiver.

### SUMMARY OF THE INVENTION

### Problems to be Solved by the Invention

The touch panel device driving scheme described above (a conventional touch panel driving scheme) works appropriately in touch panel-equipped display devices that include a touch panel formed separately from a display panel (such as a liquid crystal display panel).

However, in touch panels (hereinafter, “on-cell touch panels”) in which indium tin oxide (ITO) touch panel sensors are formed on the color filter of the display panel (such as a liquid crystal display panel), if the touch panel device driving scheme described above is used to drive the touch panel, the touch panel (which is made of ITO) will sometimes undergo discoloration.

Unlike in conventional touch panels, in on-cell touch panels, drive electrodes (electrodes corresponding to the X-axis direction sense electrodes in conventional touch panels) and sense electrodes (electrodes corresponding to the Y-axis direction sense electrodes in conventional touch panels) are both formed in the same layer. Moreover, in on-cell touch panels, an adhesive material is typically applied to the layer in which the drive electrodes and the sense electrodes are formed.

As illustrated in FIG. 9, when the conventional touch panel driving scheme is used to drive an on-cell touch panel, there are a large number of periods of time during which the drive electrodes have a high electric potential (Vtt; 3V to 10V, for example) and the sense electrodes have a low electric potential (Vr) while the touch panel is being driven. As a result, small currents flow from the drive electrodes to the sense electrodes via the adhesive applied to the layer in which the drive electrodes and the sense electrodes are formed. These small currents cause the surfaces of the ITO drive electrodes to deoxidize (due to an oxidation-reduction reaction), which causes the refractive index of the drive electrode portions to change.

Next, this concept will be described in more detail with reference to FIG. 10.

FIG. 10 is a cross-sectional view schematically illustrating portions of a display device that includes an on-cell touch panel. More specifically, FIG. 10 illustrates a layer CF (such as a glass layer) that forms a color filter, a drive electrode Tx and a sense electrode Rx that are made of ITO and are formed on the layer CF, and an adhesive GL that protects the layer in which the drive electrode Tx and the sense electrode Rx are formed and also fixes a polarizer arranged on the layer in which the drive electrode Tx and the sense electrode Rx are formed to the layer CF.

When the conventional touch panel driving scheme is used to drive the on-cell touch panel, there are a large number of periods of time during which the drive electrodes have a high electric potential (Vtt; 3V to 10V, for example) and the sense electrodes have a low electric potential (Vr) while the touch panel is being driven. As a result, a small current flows, in the direction indicated by the arrow Ar1 in FIG. 10, from the drive electrode Tx to the sense electrode Rx via the adhesive GL applied to the layer in which the drive electrode Tx and the sense electrode Rx are formed. This small current causes the surface of the ITO drive electrode Tx to deoxidize (due to an oxidation-reduction reaction), which causes the refractive index of the drive electrode Tx portion to change. This manifests as a discoloration in the overall ITO touch panel. In other words, using the conventional touch panel driving scheme to drive an on-cell touch panel can potentially cause discoloration of the touch panel.

The present invention was made in view of the abovementioned problem and aims to provide a touch panel device that utilizes a touch panel driving process that suitably prevents discoloration of an on-cell touch panel.

### Means for Solving the Problems

In order to solve the abovementioned problems, a first configuration of the present invention is a touch panel device that includes a touch panel and a touch panel controller.

In the touch panel, drive electrodes and sense electrodes are formed in the same layer.

The touch panel controller generates drive signals in a manner that keeps an integrated value of differences in electric potential between the drive electrodes and the sense electrodes less than a first value during prescribed periods in which the touch panel is driven.

### Effects of the Invention

The present invention makes it possible to provide a touch panel device that utilizes a touch panel driving process that suitably prevents discoloration of an on-cell touch panel.

### BRIEF DESCRIPTION OF THE DRAWINGS

FIG. 1 is a block diagram schematically illustrating a touch panel-equipped display device 1000 according to Embodiment 1.

FIG. 2 is a block diagram schematically illustrating a touch panel TP.

FIG. 3 is a signal waveform diagram illustrating drive signals Tx1 to Tx8 and sense signals Rx1 to Rx3 during an Nth (where N is an integer) scanning period (a period from time t1 to t2) in Embodiment 1.

FIG. 4 is a signal waveform diagram illustrating the drive signals Tx1 to Tx8 and the sense signals Rx1 to Rx3 during an (N+1)th scanning period (a period from time t2 to t3) in Embodiment 1.

FIG. 5 is a signal waveform diagram illustrating drive signals Tx1 to Tx8 and sense signals Rx1 to Rx3 during an Nth (where N is an integer) scanning period (a period from time t1 to t2) in Modification Example 1 of Embodiment 1.

FIG. 6 is a signal waveform diagram illustrating the drive signals Tx1 to Tx8 and the sense signals Rx1 to Rx3 during an (N+1)th scanning period (a period from time t2 to t3) in Modification Example 1 of Embodiment 1.

FIG. 7 is a signal waveform diagram illustrating a drive signal Tx1 and a sense signal Rx1 during an Nth (where N is an integer) scanning period (a period from time t1 to t2) in Modification Example 2 of Embodiment 1.

FIG. 8 is a signal waveform diagram illustrating the drive signals Tx1 to Tx8 and the sense signals Rx1 to Rx3 during an (N+1)th scanning period (a period from time t2 to t3) in Modification Example 2 of Embodiment 1.

FIG. 9 is a signal waveform diagram illustrating examples of a drive signal Tx1 and a sense signal Rx1.

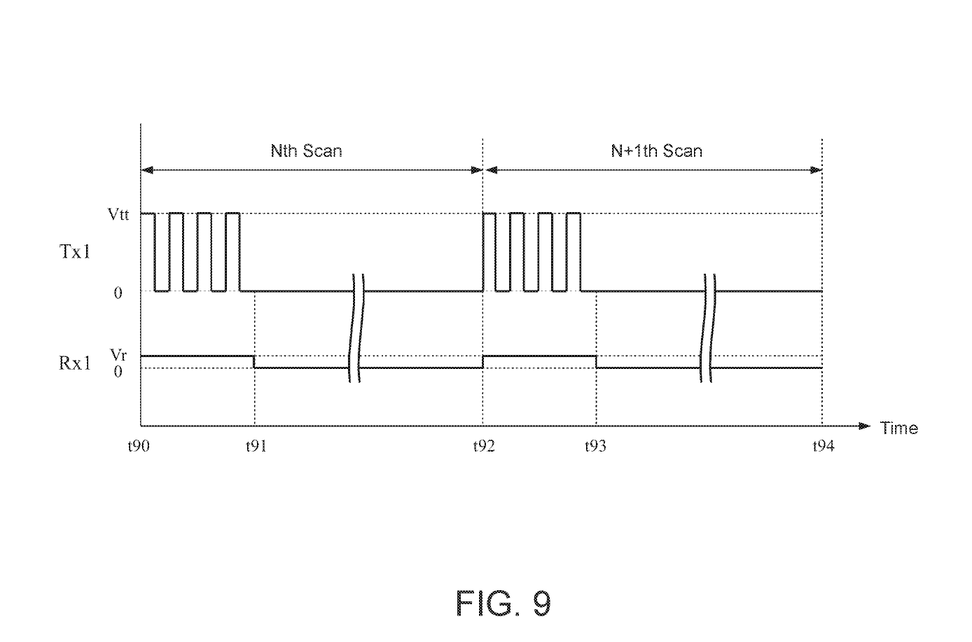

FIG. 10 is a cross-sectional view schematically illustrating portions of a display device that includes an on-cell touch panel.

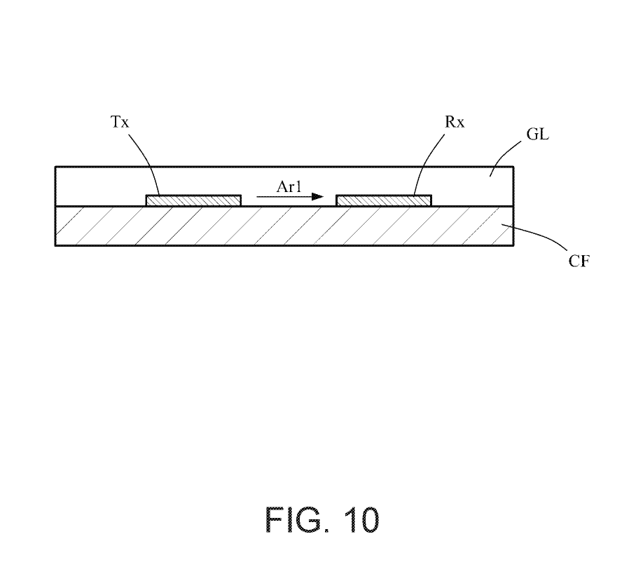

### DETAILED DESCRIPTION OF EMBODIMENTS

### Embodiment 1

Next, Embodiment 1 will be described with reference to figures.

In the following description, a touch panel-equipped display device is used as an example of a device that includes a touch panel device.

In the touch panel device according to the present embodiment, in order to prevent current from flowing only in one direction between drive electrodes and sense electrodes during prescribed periods in which a touch panel is driven, drive signals are generated in a manner that keeps the integrated value of differences in electric potential between the drive electrodes and the sense electrodes less than a prescribed value during those prescribed periods in which the touch panel is driven.

<1.1 Configuration of Touch Panel-Equipped Display Device>

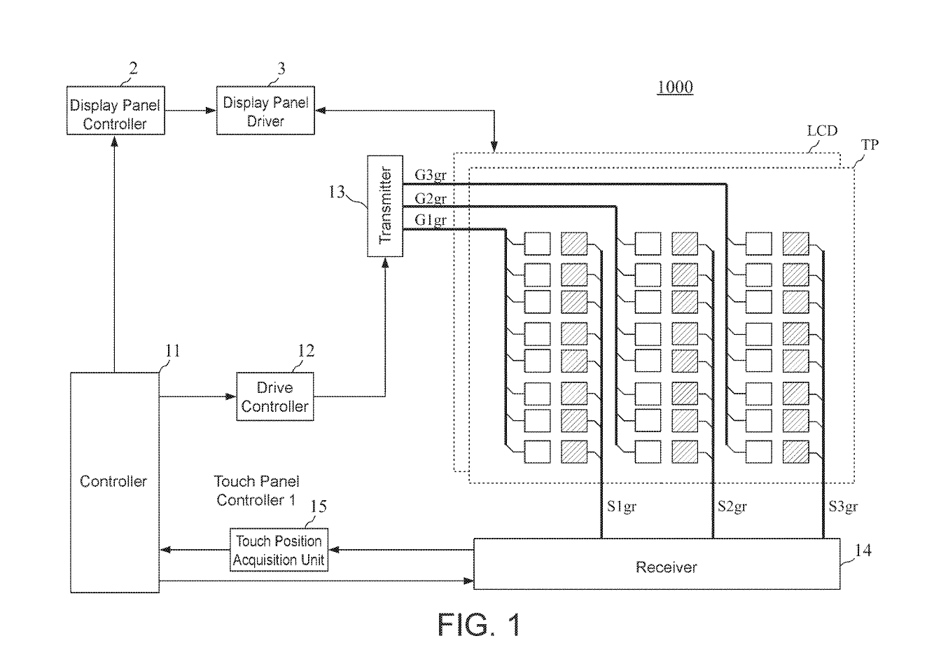

FIG. 1 is a block diagram schematically illustrating a touch panel-equipped display device 1000.

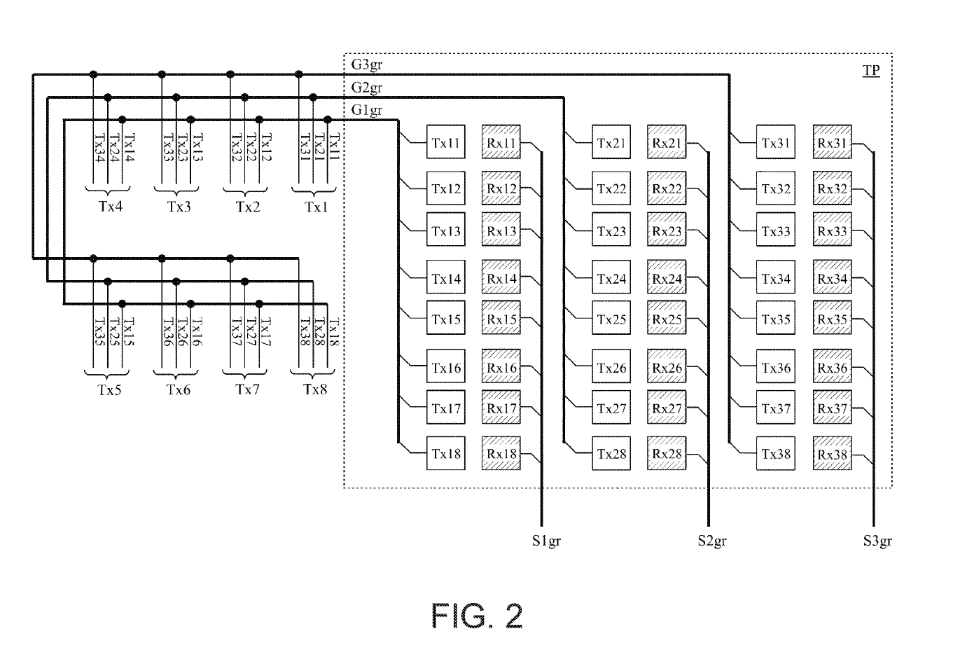

FIG. 2 is a block diagram schematically illustrating a touch panel TP.

As illustrated in FIG. 1, the touch panel-equipped display device 1000 includes a display panel (such as a liquid crystal display or an organic electroluminescent display) LCD, the touch panel TP, a touch panel controller 1, a display panel controller 2, and a display panel driver 3.

Moreover, as illustrated in FIG. 1, the touch panel controller 1 includes a controller 11, a drive controller 12, a transmitter 13, a receiver 14, and a touch position acquisition unit 15.

The touch panel TP is an on-cell touch panel in which touch panel sensors made of indium tin oxide (ITO) are formed on a color filter of the display panel LCD.

The touch panel TP is arranged covering the display surface (not illustrated in the figure) of the display panel LCD and outputs the amount of change in an electric field or the like that occurs when the touch panel surface is touched by an object such as a finger or pen (touch pen) to the touch panel controller 1 as a prescribed physical quantity (such as the current or voltage created by the change in the electric field).

As illustrated in FIGS. 1 and 2, the touch panel TP includes drive electrodes Tx11 to Tx38 and sense electrodes Rx11 to Rx38. Moreover, as illustrated in FIGS. 1 and 2, the touch panel TP includes a plurality of drive lines that are respectively connected to the drive electrodes Tx11 to Tx38 and a plurality of sense lines that are respectively connected to the sense electrodes Rx11 to Rx38. For simplicity, in FIGS. 1 and 2 the plurality of drive lines are collectively illustrated as the drive lines G1gr to G3gr, and the plurality of sense lines are collectively illustrated as the sense lines S1gr to S3gr.

More specifically:

(1) the drive lines that are respectively connected to the drive electrodes Tx11 to Tx18 are collectively illustrated as the drive line G1gr,

(2) the drive lines that are respectively connected to the drive electrodes Tx21 to Tx28 are collectively illustrated as the drive line G2gr, and

(3) the drive lines that are respectively connected to the drive electrodes Tx31 to Tx38 are collectively illustrated as the drive line G3gr.

Similarly:

(1) the drive lines that are respectively connected to the sense electrodes Rx11 to Rx18 are collectively illustrated as the sense line S1gr,

(2) the drive lines that are respectively connected to the sense electrodes Rx21 to Rx28 are collectively illustrated as the sense line S2gr, and

(3) the drive lines that are respectively connected to the sense electrodes Rx31 to Rx38 are collectively illustrated as the sense line S3gr.

In the touch panel TP, the drive electrodes Tx11 to Tx38, the sense electrodes Rx11 to Rx38, the drive lines G1gr to G3gr, and the plurality of drive lines are formed in a single layer.

As illustrated in FIG. 1, the touch panel controller 1 includes the controller 11, the drive controller 12, the transmitter 13, the receiver 14, and the touch position acquisition unit 15.

The controller 11 controls the other components of the touch panel controller 1.

The controller 11 outputs a control signal for driving the touch panel TP to the drive controller 12.

Moreover, the controller 11 receives touch position information that is output from the touch position acquisition unit 15.

Furthermore, the controller 11 outputs the touch position information that is output from the touch position acquisition unit 15 to the display panel controller 2.

In addition, the controller 11 outputs, to the receiver 14, the control signal for driving the touch panel TP as well as a control signal that makes the receiver 14 receive the signals from the sense electrodes of the touch panel TP at a prescribed time.

The drive controller 12 outputs, to the transmitter 13 and in accordance with the control signal output from the controller 11, a control signal that makes the transmitter 13 output drive signals to the touch panel TP via the drive lines.

The transmitter 13 outputs these drive signals (drive pulse signals) via the drive lines in accordance with the control signal output from the drive controller 12.

The receiver 14 controls the electric potential of the sense electrodes of the touch panel TP in accordance with the control signal from the controller 11 in order to make that electric potential take a prescribed value at a prescribed time (that is, the receiver 14 applies a prescribed bias voltage).

The receiver 14 also detects, via the sense lines S1gr to S3gr, electric field changes that occur when an object contacts the touch panel surface of the touch panel TP. More specifically, the drive signals (drive pulse signals) output to the drive lines by the transmitter 13 create electric fields between the drive electrodes and the sense electrodes. When an object contacts the touch panel surface of the touch panel TP, the electric fields between the drive electrodes and the sense electrodes arranged near where that object made contact change. Moreover, signals corresponding to these electric field changes are input to the receiver 14 via the sense lines. In other words, the receiver 14 receives, via the sense lines S1gr to S2gr, signals (sense signals) corresponding to electric field changes that occur when an object contacts the touch panel surface of the touch panel TP. Furthermore, the receiver 14 outputs the received sense signals to the touch position acquisition unit 15.

The touch position acquisition unit 15 receives the sense signals output from the receiver 14. The touch position acquisition unit 15 identifies, on the basis of these sense signals, the position (coordinate position) at which the object contacted (touched) the touch panel surface of the touch panel TP. The touch position acquisition unit 15 then outputs the identified positional information (touch position information) to the controller 11.

The display panel controller 2 receives the touch position information output from the controller 11. The display panel controller 2 determines, on the basis of the received touch position information, what data (display data) to display on the display panel LCD. The display panel controller 2 then outputs, to the display panel driver 3, a control signal for making the display panel LCD display the appropriate display data.

The display panel driver 3 receives the control signal output from the display panel controller 2 and drives the display panel LCD in accordance with this control signal to make the display panel LCD display the appropriate display data.

<1.2 Operation of Touch Panel-Equipped Display Device>

Next, the operation of the touch panel-equipped display device 1000 configured as described above will be described.

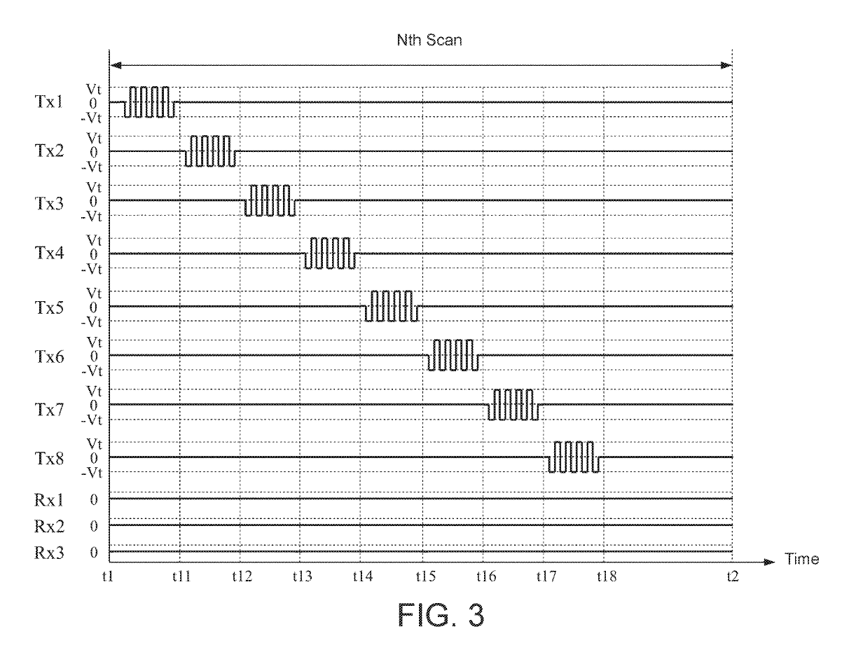

FIG. 3 is a signal waveform diagram illustrating drive signals Tx1 to Tx8 and sense signals Rx1 to Rx3 during an Nth (where N is an integer) scanning period (a period from time t1 to t2).

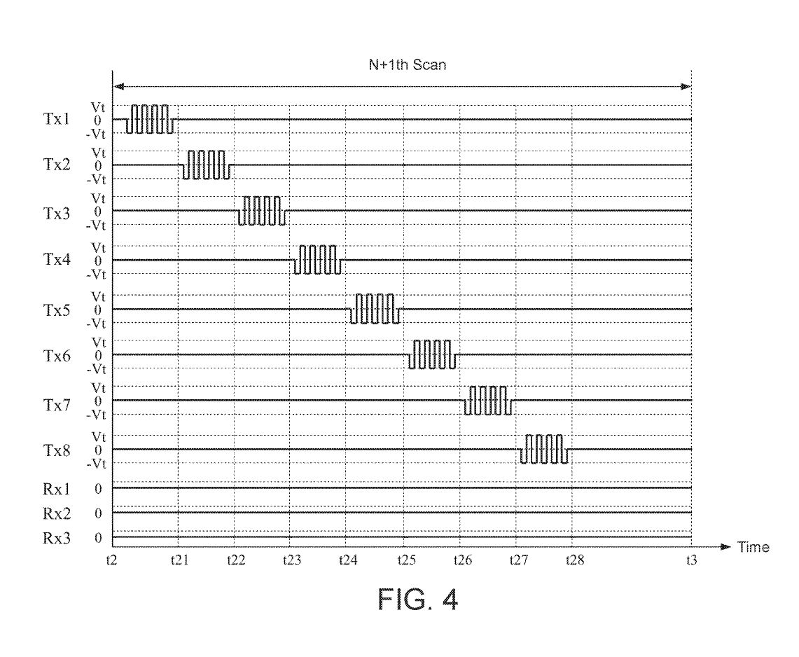

FIG. 4 is a signal waveform diagram illustrating the drive signals Tx1 to Tx8 and the sense signals Rx1 to Rx3 during an (N+1)th scanning period (a period from time t2 to t3).

(A1) The drive signal Txl is a signal for driving the drive electrodes Tx11, Tx21, and Tx31.

(A2) The drive signal Tx2 is a signal for driving the drive electrodes Tx12, Tx22, and Tx32.

(A3) The drive signal Tx3 is a signal for driving the drive electrodes Tx13, Tx23, and Tx33.

(A4) The drive signal Tx4 is a signal for driving the drive electrodes Tx14, Tx24, and Tx34.

(A5) The drive signal Tx5 is a signal for driving the drive electrodes Tx15, Tx25, and Tx35.

(A6) The drive signal Tx6 is a signal for driving the drive electrodes Tx16, Tx26, and Tx36.

(A7) The drive signal Tx7 is a signal for driving the drive electrodes Tx17, Tx27, and Tx37.

(A8) The drive signal Tx8 is a signal for driving the drive electrodes Tx18, Tx28, and Tx38.

(B1) The sense signal Rx1 is the received signal from the sense electrodes Rx11 to Rx18.

(B2) The sense signal Rx2 is the received signal from the sense electrodes Rx21 to Rx28.

(B3) The sense signal Rx3 is the received signal from the sense electrodes Rx31 to Rx38.

Next, the operation of the touch panel-equipped display device 1000 will be described with reference to the timing charts in FIGS. 3 and 4.

(Time tl to t11):

During the period from time t1 to t11, the drive controller 12 controls the transmitter 13 in accordance with the control signal from the controller 11. In other words, the drive controller 12 makes the transmitter 13 output the pulse signal illustrated in FIG. 3 to the drive electrodes Tx11, Tx21, and Tx31 via the drive lines G1gr to G3gr. As illustrated in FIG. 3, the drive signal Tx1 that is output from the transmitter 13 to the drive electrodes Tx11, Tx21, and Tx31 via the drive lines G1gr to G3gr during the period from time t1 to t11 is a pulse signal that alternates between signal values (voltages) of −Vt and +Vt (where Vt>0; Vt=5V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t1 to t11, the receiver 14 may: (1) apply a bias voltage via the sense lines in order to make the electric potential of the sense electrodes Rx11, Rx21, and Rx31 equal to Vr (where Vr>0; Vr=1.65V, for example), or (2) apply a bias voltage via the sense lines in order to make the electric potential of the sense electrodes other than the sense electrodes Rx11, Rx21, and Rx31 equal to −Vr (where Vr≧0; Vr=1.65V, for example).

While the drive electrodes Tx11, Tx21, and Tx31 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t1 to t11, the drive electrodes other than the drive electrodes Tx11, Tx21, and Tx31 are not driven, and therefore in order to ensure that the electric potential of those drive electrodes other than the drive electrodes Tx11, Tx21, and Tx31 is equal to 0V, the transmitter 13 does not output drive signals to any of the drive electrodes other than the drive electrodes Tx11, Tx21, and Tx31.

(Time t11 to t12):

During the period from time t11 to t12, the drive controller 12 controls the transmitter 13 in accordance with the control signal from the controller 11. In other words, the drive controller 12 makes the transmitter 13 output the pulse signal illustrated in FIG. 3 to the drive electrodes Tx12, Tx22, and Tx32 via the drive lines G1gr to G3gr. As illustrated in FIG. 3, the drive signal Tx2 that is output from the transmitter 13 to the drive electrodes Tx12, Tx22, and Tx32 via the drive lines G1gr to G3gr during the period from time t11 to t12 is a pulse signal that alternates between signal values (voltages) of −Vt and +Vt (where Vt>0; Vt=5V, for example).

Moreover, during the period from time t11 to t12, in order to ensure that the electric potential of all of the sense electrodes Rx11 to Rx38 is equal to 0V, the receiver 14 does not apply a bias voltage to the sense electrodes.

Alternatively, during the period from time t11 to t12, the receiver 14 may: (1) apply a bias voltage via the sense lines in order to make the electric potential of the sense electrodes Rx12, Rx22, and Rx32 equal to Vr (where Vr≧0; Vr=1.65V, for example), or (2) apply a bias voltage via the sense lines in order to make the electric potential of the sense electrodes other than the sense electrodes Rx12, Rx22, and Rx32 equal to −Vr (where Vr≧0; Vr=1.65V, for example).

While the drive electrodes Tx12, Tx22, and Tx32 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t11 to t12, the drive electrodes other than the drive electrodes Tx12, Tx22, and Tx32 are not driven, and therefore in order to ensure that the electric potential of those drive electrodes other than the drive electrodes Tx12, Tx22, and Tx32 is equal to 0V, the transmitter 13 does not output drive signals to any of the drive electrodes other than the drive electrodes Tx12, Tx22, and Tx32.

(Time t12 to t13):

During the period from time t12 to t13, the drive controller 12 controls the transmitter 13 in accordance with the control signal from the controller 11. In other words, the drive controller 12 makes the transmitter 13 output the pulse signal illustrated in FIG. 3 to the drive electrodes Tx13, Tx23, and Tx33 via the drive lines G1gr to G3gr. As illustrated in FIG. 3, the drive signal Tx3 that is output from the transmitter 13 to the drive electrodes Tx13, Tx23, and Tx33 via the drive lines G1gr to G3gr during the period from time t12 to t13 is a pulse signal that alternates between signal values (voltages) of −Vt and +Vt (where Vt>0; Vt=5V, for example).

Moreover, during the period from time t12 to t13, in order to ensure that the electric potential of all of the sense electrodes Rx11 to Rx38 is equal to 0V, the receiver 14 does not apply a bias voltage to the sense electrodes.

Alternatively, during the period from time t12 to t13, the receiver 14 may: (1) apply a bias voltage via the sense lines in order to make the electric potential of the sense electrodes Rx13, Rx23, and Rx33 equal to Vr (where Vr≧0; Vr=1.65V, for example), or (2) apply a bias voltage via the sense lines in order to make the electric potential of the sense electrodes other than the sense electrodes Rx13, Rx23, and Rx33 equal to −Vr (where Vr≧0; Vr=1.65V, for example).

While the drive electrodes Tx13, Tx23, and Tx33 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t12 to t13, the drive electrodes other than the drive electrodes Tx13, Tx23, and Tx33 are not driven, and therefore in order to ensure that the electric potential of those drive electrodes other than the drive electrodes Tx13, Tx23, and Tx33 is equal to 0V, the transmitter 13 does not output drive signals to any of the drive electrodes other than the drive electrodes Tx13, Tx23, and Tx33.

(Time t13 to t14):

During the period from time t13 to t14, the drive controller 12 controls the transmitter 13 in accordance with the control signal from the controller 11. In other words, the drive controller 12 makes the transmitter 13 output the pulse signal illustrated in FIG. 3 to the drive electrodes Tx14, Tx24, and Tx34 via the drive lines G1gr to G3gr. As illustrated in FIG. 3, the drive signal Tx4 that is output from the transmitter 13 to the drive electrodes Tx14, Tx24, and Tx34 via the drive lines G1gr to G3gr during the period from time t13 to t14 is a pulse signal that alternates between signal values (voltages) of −Vt and +Vt (where Vt>0; Vt=5V, for example).

Moreover, during the period from time t13 to t14, in order to ensure that the electric potential of all of the sense electrodes Rx11 to Rx38 is equal to 0V, the receiver 14 does not apply a bias voltage to the sense electrodes.

Alternatively, during the period from time t13 to t14, the receiver 14 may: (1) apply a bias voltage via the sense lines in order to make the electric potential of the sense electrodes Rx14, Rx24, and Rx34 equal to Vr (where Vr≧0; Vr=1.65V, for example), or (2) apply a bias voltage via the sense lines in order to make the electric potential of the sense electrodes other than the sense electrodes Rx14, Rx24, and Rx34 equal to −Vr (where Vr≧0; Vr=1.65V, for example).

While the drive electrodes Tx14, Tx24, and Tx34 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t13 to t14, the drive electrodes other than the drive electrodes Tx14, Tx24, and Tx34 are not driven, and therefore in order to ensure that the electric potential of those drive electrodes other than the drive electrodes Tx14, Tx24, and Tx34 is equal to 0V, the transmitter 13 does not output drive signals to any of the drive electrodes other than the drive electrodes Tx14, Tx24, and Tx34.

(Time t14 to t15):

During the period from time t14 to t15, the drive controller 12 controls the transmitter 13 in accordance with the control signal from the controller 11. In other words, the drive controller 12 makes the transmitter 13 output the pulse signal illustrated in FIG. 3 to the drive electrodes Tx15, Tx25, and Tx35 via the drive lines G1gr to G3gr. As illustrated in FIG. 3, the drive signal Tx5 that is output from the transmitter 13 to the drive electrodes Tx15, Tx25, and Tx35 via the drive lines G1gr to G3gr during the period from time t14 to t15 is a pulse signal that alternates between signal values (voltages) of −Vt and +Vt (where Vt>0; Vt=5V, for example).

Moreover, during the period from time t14 to t15, in order to ensure that the electric potential of all of the sense electrodes Rx11 to Rx38 is equal to 0V, the receiver 14 does not apply a bias voltage to the sense electrodes.

Alternatively, during the period from time t14 to t15, the receiver 14 may: (1) apply a bias voltage via the sense lines in order to make the electric potential of the sense electrodes Rx15, Rx25, and Rx35 equal to Vr (where Vr≧0; Vr=1.65V, for example), or (2) apply a bias voltage via the sense lines in order to make the electric potential of the sense electrodes other than the sense electrodes Rx15, Rx25, and Rx35 equal to −Vr (where Vr≧0; Vr=1.65V, for example).

While the drive electrodes Tx15, Tx25, and Tx35 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t14 to t15, the drive electrodes other than the drive electrodes Tx15, Tx25, and Tx35 are not driven, and therefore in order to ensure that the electric potential of those drive electrodes other than the drive electrodes Tx15, Tx25, and Tx35 is equal to 0V, the transmitter 13 does not output drive signals to any of the drive electrodes other than the drive electrodes Tx15, Tx25, and Tx35.

(Time t15 to t16):

During the period from time t15 to t16, the drive controller 12 controls the transmitter 13 in accordance with the control signal from the controller 11. In other words, the drive controller 12 makes the transmitter 13 output the pulse signal illustrated in FIG. 3 to the drive electrodes Tx16, Tx26, and Tx36 via the drive lines G1gr to G3gr. As illustrated in FIG. 3, the drive signal Tx6 that is output from the transmitter 13 to the drive electrodes Tx16, Tx26, and Tx36 via the drive lines G1gr to G3gr during the period from time t15 to t16 is a pulse signal that alternates between signal values (voltages) of −Vt and +Vt (where Vt>0; Vt=5V, for example).

Moreover, during the period from time t15 to t16, in order to ensure that the electric potential of all of the sense electrodes Rx11 to Rx38 is equal to 0V, the receiver 14 does not apply a bias voltage to the sense electrodes.

Alternatively, during the period from time t15 to t16, the receiver 14 may: (1) apply a bias voltage via the sense lines in order to make the electric potential of the sense electrodes Rx16, Rx26, and Rx36 equal to Vr (where Vr≧0; Vr=1.65V, for example), or (2) apply a bias voltage via the sense lines in order to make the electric potential of the sense electrodes other than the sense electrodes Rx16, Rx26, and Rx36 equal to −Vr (where Vr≧0; Vr=1.65V, for example).

While the drive electrodes Tx16, Tx26, and Tx36 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t15 to t16, the drive electrodes other than the drive electrodes Tx16, Tx26, and Tx36 are not driven, and therefore in order to ensure that the electric potential of those drive electrodes other than the drive electrodes Tx16, Tx26, and Tx36 is equal to 0V, the transmitter 13 does not output drive signals to any of the drive electrodes other than the drive electrodes Tx16, Tx26, and Tx36.

(Time t16 to t17):

During the period from time t16 to t17, the drive controller 12 controls the transmitter 13 in accordance with the control signal from the controller 11. In other words, the drive controller 12 makes the transmitter 13 output the pulse signal illustrated in FIG. 3 to the drive electrodes Tx17, Tx27, and Tx37 via the drive lines G1gr to G3gr. As illustrated in FIG. 3, the drive signal Tx7 that is output from the transmitter 13 to the drive electrodes Tx17, Tx27, and Tx37 via the drive lines G1gr to G3gr during the period from time t16 to t17 is a pulse signal that alternates between signal values (voltages) of −Vt and +Vt (where Vt>0; Vt=5V, for example).

Moreover, during the period from time t16 to t17, in order to ensure that the electric potential of all of the sense electrodes Rx11 to Rx38 is equal to 0V, the receiver 14 does not apply a bias voltage to the sense electrodes.

Alternatively, during the period from time t16 to t17, the receiver 14 may: (1) apply a bias voltage via the sense lines in order to make the electric potential of the sense electrodes Rx17, Rx27, and Rx37 equal to Vr (where Vr≧0; Vr=1.65V, for example), or (2) apply a bias voltage via the sense lines in order to make the electric potential of the sense electrodes other than the sense electrodes Rx17, Rx27, and Rx37 equal to −Vr (where Vr≧0; Vr=1.65V, for example).

While the drive electrodes Tx17, Tx27, and Tx37 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t16 to t17, the drive electrodes other than the drive electrodes Tx17, Tx27, and Tx37 are not driven, and therefore in order to ensure that the electric potential of those drive electrodes other than the drive electrodes Tx17, Tx27, and Tx37 is equal to 0V, the transmitter 13 does not output drive signals to any of the drive electrodes other than the drive electrodes Tx17, Tx27, and Tx37.

(Time t17 to t18):

During the period from time t17 to t18, the drive controller 12 controls the transmitter 13 in accordance with the control signal from the controller 11. In other words, the drive controller 12 makes the transmitter 13 output the pulse signal illustrated in FIG. 3 to the drive electrodes Tx18, Tx28, and Tx38 via the drive lines G1gr to G3gr. As illustrated in FIG. 3, the drive signal Tx8 that is output from the transmitter 13 to the drive electrodes Tx18, Tx28, and Tx38 via the drive lines G1gr to G3gr during the period from time t17 to t18 is a pulse signal that alternates between signal values (voltages) of −Vt and +Vt (where Vt>0; Vt=5V, for example).

Moreover, during the period from time t17 to t18, in order to ensure that the electric potential of all of the sense electrodes Rx11 to Rx38 is equal to 0V, the receiver 14 does not apply a bias voltage to the sense electrodes.

Alternatively, during the period from time t17 to t18, the receiver 14 may: (1) apply a bias voltage via the sense lines in order to make the electric potential of the sense electrodes Rx18, Rx28, and Rx38 equal to Vr (where Vr≧0; Vr=1.65V, for example), or (2) apply a bias voltage via the sense lines in order to make the electric potential of the sense electrodes other than the sense electrodes Rx18, Rx28, and Rx38 equal to −Vr (where Vr≧0; Vr=1.65V, for example).

While the drive electrodes Tx18, Tx28, and Tx38 are being driven using this control process, the touch panel-equipped display device 1000 repeatedly alternates between (1) a state in which the electric potential of the drive electrodes is greater than the electric potential of the sense electrodes and (2) a state in which the electric potential of the drive electrodes is less than the electric potential of the sense electrodes.

This makes it possible to suitably prevent small currents from flowing only from the drive electrodes to the sense electrodes via the adhesive applied to the layer in which the drive electrodes and the sense electrodes are formed (that is, only in one direction) in the touch panel-equipped display device 1000. This, in turn, makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change.

During the period from time t17 to t18, the drive electrodes other than the drive electrodes Tx18, Tx28, and Tx38 are not driven, and therefore in order to ensure that the electric potential of those drive electrodes other than the drive electrodes Tx18, Tx28, and Tx38 is equal to 0V, the transmitter 13 does not output drive signals to any of the drive electrodes other than the drive electrodes Tx18, Tx28, and Tx38.

(Time t18 to t2):

During the period from time t18 to t2, the drive controller 12 controls the transmitter 13 to not drive any of the drive electrodes Tx11 to Tx38. In other words, in order to make the electric potential of all of the drive electrodes equal to 0V, the drive controller 12 puts the transmitter 13 into a state in which no drive signals are output.

Moreover, although the electric potential of all of the sense electrodes Rx11 to Rx38 is equal to 0V during the period from time t18 to t2 in FIG. 3, the receiver 14 may alternatively apply a bias voltage via the sense lines to make the electric potential of all of the sense electrodes Rx11 to Rx38 equal to −Vr (where Vr≧0; Vr=1.65V, for example).

The control process described above constitutes an Nth (where N is an integer) scanning process in the touch panel-equipped display device 1000. The scanning process for the next (N+1)th scanning period (from time t2 to t3) is executed in the same manner as the Nth scanning process. Moreover, the (N+2)th and subsequent scanning processes are also executed in the same manner.

In the touch panel-equipped display device 1000, the drive signals illustrated in FIG. 3 create electric fields between the drive electrodes and the sense electrodes. These electric fields change when the touch panel surface is touched, and currents corresponding to these electric field changes flow to the receiver 14 via the sense lines S1gr to S3gr. In other words, the receiver 14 receives sense signals corresponding to the electric field changes. Moreover, in the touch panel-equipped display device 1000, the touch position acquisition unit detects changes in the sense signals corresponding to the electric field changes that occur when the touch panel surface is touched, thereby making it possible to detect the touch position.

Furthermore, the detected touch position information is output to the display panel controller 2 via the controller 11. The display panel controller 2 then outputs, to the display panel driver 3, a control signal for changing the display data or the like as necessary in accordance with the touch position. The display panel driver 3 then drives the display panel LCD in accordance with this control signal from the display panel controller 2.

In the touch panel-equipped display device 1000 as described above, the drive signals are generated in a manner that prevents small currents from flowing only from the drive electrodes to the sense electrodes via the adhesive applied to the layer in which the drive electrodes and the sense electrodes are formed (that is, only in one direction), and the touch panel TP is driven using the drive signals thus generated. This makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change, which in turn makes it possible to suitably prevent discoloration of the on-cell touch panel in the touch panel-equipped display device 1000.

### MODIFICATION EXAMPLE 1

Next, Modification Example 1 of Embodiment 1 will be described.

Note that the following description will focus only on aspects that are unique to the present modification example, and detailed descriptions of aspects that are the same as in the embodiment described above will be omitted.

A touch panel-equipped display device according to the present modification example has the same configuration as the touch panel-equipped display device 1000 according to Embodiment 1.

However, in the touch panel-equipped display device of the present modification example, the touch panel TP is driven using drive signals and sense signals that are different from the drive signals and sense signals used in the touch panel-equipped display device 1000 of Embodiment 1.

Next, the operation of the touch panel-equipped display device according to the present modification example will be described.

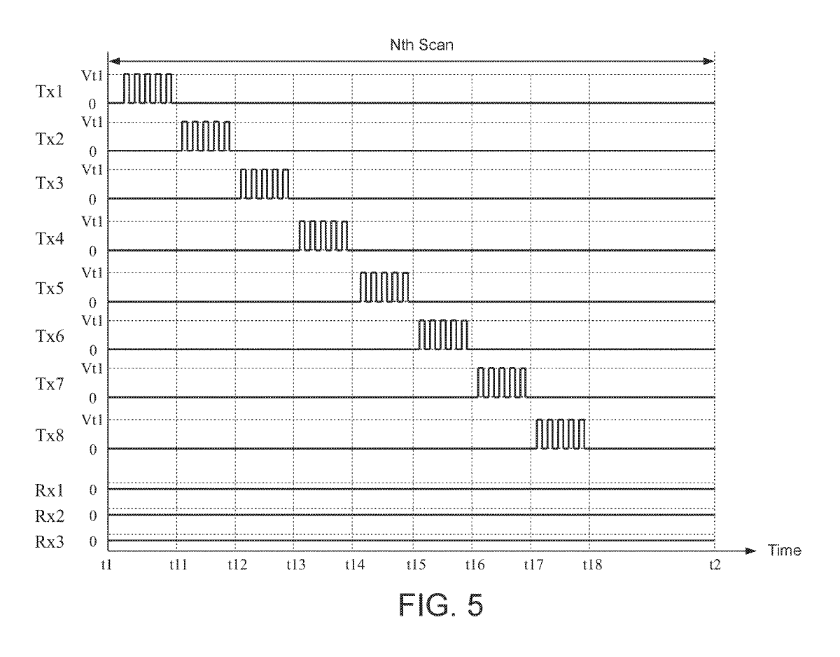

FIG. 5 is a signal waveform diagram illustrating drive signals Tx1 to Tx8 and sense signals Rx1 to Rx3 during an Nth (where N is an integer) scanning period (a period from time t1 to t2) in the present modification example.

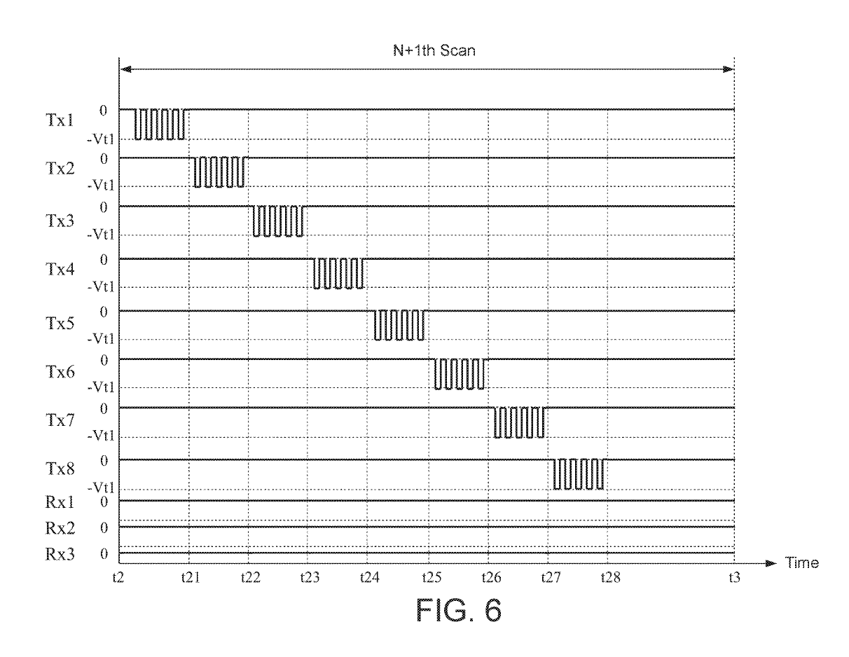

FIG. 6 is a signal waveform diagram illustrating the drive signals Tx1 to Tx8 and the sense signals Rx1 to Rx3 during an (N+1)th scanning period (a period from time t2 to t3).

First, the process executed during the Nth scanning period will be described.

(Time t1 to t11):

During the period from time t1 to t11, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx1 that is output from the transmitter 13 to the drive electrodes Tx11, Tx21, and Tx31 via the drive lines G1gr to G3gr during the period from time t1 to t11 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t1 to t11, the receiver 14 may: (1) apply a bias voltage via the sense lines in order to make the electric potential of the sense electrodes Rx11, Rx21, and Rx31 equal to Vr (where Vr≧0; Vr=1.65V, for example), or (2) not apply a bias voltage in order to ensure the electric potential of the sense electrodes other than the sense electrodes Rx11, Rx21, and Rx31 is equal to 0V.

(Time t11 to t12):

During the period from time t11 to t12, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx2 that is output from the transmitter 13 to the drive electrodes Tx12, Tx22, and Tx32 via the drive lines G1gr to G3gr during the period from time t11 to t12 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t11 to t12, the receiver 14 may: (1) apply a bias voltage via the sense lines in order to make the electric potential of the sense electrodes Rx12, Rx22, and Rx32 equal to Vr (where Vr≧0; Vr=1.65V, for example), or (2) not apply a bias voltage in order to ensure the electric potential of the sense electrodes other than the sense electrodes Rx12, Rx22, and Rx32 is equal to 0V.

(Time t12 to t13):

During the period from time t12 to t13, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx3 that is output from the transmitter 13 to the drive electrodes Tx13, Tx23, and Tx33 via the drive lines G1gr to G3gr during the period from time t12 to t13 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t12 to t13, the receiver 14 may: (1) apply a bias voltage via the sense lines in order to make the electric potential of the sense electrodes Rx13, Rx23, and Rx33 equal to Vr (where Vr≧0; Vr=1.65V, for example), or (2) not apply a bias voltage in order to ensure the electric potential of the sense electrodes other than the sense electrodes Rx13, Rx23, and Rx33 is equal to 0V.

(Time t13 to t14):

During the period from time t13 to t14, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx4 that is output from the transmitter 13 to the drive electrodes Tx14, Tx24, and Tx34 via the drive lines G1gr to G3gr during the period from time t13 to t14 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t13 to t14, the receiver 14 may: (1) apply a bias voltage via the sense lines in order to make the electric potential of the sense electrodes Rx14, Rx24, and Rx34 equal to Vr (where Vr≧0; Vr=1.65V, for example), or (2) not apply a bias voltage in order to ensure the electric potential of the sense electrodes other than the sense electrodes Rx14, Rx24, and Rx34 is equal to 0V.

(Time t14 to t15):

During the period from time t14 to t15, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx5 that is output from the transmitter 13 to the drive electrodes Tx15, Tx25, and Tx35 via the drive lines G1gr to G3gr during the period from time t14 to t15 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t14 to t15, the receiver 14 may: (1) apply a bias voltage via the sense lines in order to make the electric potential of the sense electrodes Rx15, Rx25, and Rx35 equal to Vr (where Vr≧0; Vr=1.65V, for example), or (2) not apply a bias voltage in order to ensure the electric potential of the sense electrodes other than the sense electrodes Rx15, Rx25, and Rx35 is equal to 0V.

(Time t15 to t16):

During the period from time t15 to t16, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx6 that is output from the transmitter 13 to the drive electrodes Tx16, Tx26, and Tx36 via the drive lines G1gr to G3gr during the period from time t15 to t16 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t15 to t16, the receiver 14 may: (1) apply a bias voltage via the sense lines in order to make the electric potential of the sense electrodes Rx16, Rx26, and Rx36 equal to Vr (where Vr≧0; Vr=1.65V, for example), or (2) not apply a bias voltage via the sense lines in order to ensure the electric potential of the sense electrodes other than the sense electrodes Rx16, Rx26, and Rx36 is equal to 0V.

(Time t16 to t17):

During the period from time t16 to t17, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx7 that is output from the transmitter 13 to the drive electrodes Tx17, Tx27, and Tx37 via the drive lines G1gr to G3gr during the period from time t16 to t17 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t16 to t17, the receiver 14 may: (1) apply a bias voltage via the sense lines in order to make the electric potential of the sense electrodes Rx17, Rx27, and Rx37 equal to Vr (where Vr≧0; Vr=1.65V, for example), or (2) not apply a bias voltage in order to ensure the electric potential of the sense electrodes other than the sense electrodes Rx17, Rx27, and Rx37 is equal to 0V.

(Time t17 to t18):

During the period from time t17 to t18, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx8 that is output from the transmitter 13 to the drive electrodes Tx18, Tx28, and Tx38 via the drive lines G1gr to G3gr during the period from time t17 to t18 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t17 to t18, the receiver 14 may: (1) apply a bias voltage via the sense lines in order to make the electric potential of the sense electrodes Rx18, Rx28, and Rx38 equal to Vr (where Vr≧0; Vr=1.65V, for example), or (2) not apply a bias voltage in order to ensure the electric potential of the sense electrodes other than the sense electrodes Rx18, Rx28, and Rx38 is equal to 0V.

(Time t18 to t2):

During the period from time t18 to t2, the drive controller 12 controls the transmitter 13 to not drive any of the drive electrodes Tx11 to Tx38. In other words, in order to make the electric potential of all of the drive electrodes equal to 0V, the drive controller 12 puts the transmitter 13 into a state in which no drive signals are output.

Moreover, as illustrated in FIG. 5, in order to ensure that the electric potential of all of the sense electrodes Rx11 to Rx38 is equal to 0V during the period from time t18 to t2, no bias voltage is applied to the sense electrodes.

Next, the process executed during the (N+1)th scanning period will be described.

(Time t2 to t21):

During the period from time t2 to t21, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx1 that is output from the transmitter 13 to the drive electrodes Tx11, Tx21, and Tx31 via the drive lines G1gr to G3gr during the period from time t2 to t21 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t2 to t21, the receiver 14 may: (1) apply a bias voltage via the sense lines in order to make the electric potential of the sense electrodes Rx11, Rx21, and Rx31 equal to −Vr (where Vr≧0; Vr=1.65V, for example), or (2) apply a bias voltage via the sense lines in order to ensure that the electric potential of the sense electrodes other than the sense electrodes Rx11, Rx21, and Rx31 is equal to 0V.

(Time t21 to t22):

During the period from time t21 to t22, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx2 that is output from the transmitter 13 to the drive electrodes Tx12, Tx22, and Tx32 via the drive lines G1gr to G3gr during the period from time t21 to t22 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t21 to t22, the receiver 14 may: (1) apply a bias voltage via the sense lines in order to make the electric potential of the sense electrodes Rx12, Rx22, and Rx32 equal to −Vr (where Vr≧0; Vr=1.65V, for example), or (2) apply a bias voltage via the sense lines in order to ensure that the electric potential of the sense electrodes other than the sense electrodes Rx12, Rx22, and Rx32 is equal to 0V.

(Time t22 to t23):

During the period from time t21 to t23, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx2 that is output from the transmitter 13 to the drive electrodes Tx13, Tx23, and Tx33 via the drive lines G1gr to G3gr during the period from time t22 to t23 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t22 to t23, the receiver 14 may: (1) apply a bias voltage via the sense lines in order to make the electric potential of the sense electrodes Rx13, Rx23, and Rx33 equal to −Vr (where Vr≧0; Vr=1.65V, for example), or (2) apply a bias voltage via the sense lines in order to ensure that the electric potential of the sense electrodes other than the sense electrodes Rx13, Rx23, and Rx33 is equal to 0V.

(Time t23 to t24):

During the period from time t23 to t24, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx4 that is output from the transmitter 13 to the drive electrodes Tx14, Tx24, and Tx34 via the drive lines G1gr to G3gr during the period from time t23 to t24 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t23 to t24, the receiver 14 may: (1) apply a bias voltage via the sense lines in order to make the electric potential of the sense electrodes Rx14, Rx24, and Rx34 equal to −Vr (where Vr≧0; Vr=1.65V, for example), or (2) apply a bias voltage via the sense lines in order to ensure that the electric potential of the sense electrodes other than the sense electrodes Rx14, Rx24, and Rx34 is equal to 0V.

(Time t24 to t25):

During the period from time t24 to t25, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx5 that is output from the transmitter 13 to the drive electrodes Tx15, Tx25, and Tx35 via the drive lines G1gr to G3gr during the period from time t24 to t25 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t24 to t25, the receiver 14 may: (1) apply a bias voltage via the sense lines in order to make the electric potential of the sense electrodes Rx15, Rx25, and Rx35 equal to −Vr (where Vr≧0; Vr=1.65V, for example), or (2) apply a bias voltage via the sense lines in order to ensure that the electric potential of the sense electrodes other than the sense electrodes Rx15, Rx25, and Rx35 is equal to 0V.

(Time t25 to t26):

During the period from time t25 to t26, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx6 that is output from the transmitter 13 to the drive electrodes Tx16, Tx26, and Tx36 via the drive lines G1gr to G3gr during the period from time t25 to t26 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t25 to t26, the receiver 14 may: (1) apply a bias voltage via the sense lines in order to make the electric potential of the sense electrodes Rx16, Rx26, and Rx36 equal to −Vr (where Vr≧0; Vr=1.65V, for example), or (2) apply a bias voltage via the sense lines in order to ensure that the electric potential of the sense electrodes other than the sense electrodes Rx16, Rx26, and Rx36 is equal to 0V.

(Time t26 to t27):

During the period from time t26 to t27, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx7 that is output from the transmitter 13 to the drive electrodes Tx17, Tx27, and Tx37 via the drive lines G1gr to G3gr during the period from time t26 to t27 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t26 to t27, the receiver 14 may: (1) apply a bias voltage via the sense lines in order to make the electric potential of the sense electrodes Rx17, Rx27, and Rx37 equal to −Vr (where Vr≧0; Vr=1.65V, for example), or (2) apply a bias voltage via the sense lines in order to ensure that the electric potential of the sense electrodes other than the sense electrodes Rx17, Rx27, and Rx37 is equal to 0V.

(Time t27 to t28):

During the period from time t27 to t28, the drive controller 12 controls the transmitter 13 in accordance with the control signal from the controller 11. In other words, the drive controller 12 makes the transmitter 13 output the pulse signal illustrated in FIG. 5 via the drive lines G1gr to G3gr. As illustrated in FIG. 5, the drive signal Tx8 that is output from the transmitter 13 to the drive electrodes Tx18, Tx28, and Tx38 via the drive lines G1gr to G3gr during the period from time t27 to t28 is a pulse signal that alternates between signal values (voltages) of 0V and −Vt1 (where Vt1>0; Vt1=10V, for example).

Moreover, during the period from time t2 to t3, in order to ensure that the electric potential of all of the sense electrodes Rx11 to Rx38 is equal to 0V, the receiver 14 does not apply a bias voltage to the sense electrodes.

Alternatively, during the period from time t27 to t28, the receiver 14 may: (1) apply a bias voltage via the sense lines in order to make the electric potential of the sense electrodes Rx18, Rx28, and Rx38 equal to −Vr (where Vr≧0; Vr=1.65V, for example), or (2) apply a bias voltage via the sense lines in order to ensure that the electric potential of the sense electrodes other than the sense electrodes Rx18, Rx28, and Rx38 is equal to 0V.

(Time t28 to t3):

During the period from time t28 to t3, the drive controller 12 controls the transmitter 13 to not drive any of the drive electrodes Tx11 to Tx38. In other words, in order to make the electric potential of all of the drive electrodes equal to 0V, the drive controller 12 puts the transmitter 13 into a state in which no drive signals are output.

Moreover, as illustrated in FIG. 5, in order to ensure that the electric potential of all of the sense electrodes Rx11 to Rx38 is equal to 0V during the period from time t28 to t3, no bias voltage is applied to the sense electrodes.

The process described above constitutes the (N+1)th scanning process. The touch panel-equipped display device according to the present modification example then proceeds to alternately execute scanning processes executed in the same manner as the Nth scanning process and scanning processes executed in the same manner as the (N+1)th scanning process.

As described above, in the touch panel-equipped display device of the present modification example, the drive signals are generated such that the integrated value of the currents that flow through the adhesive applied to the layer in which the drive electrodes and the sense electrodes are formed is substantially equal to zero over two scanning process periods in the touch panel TP (over the period from time t1 to t3 in FIGS. 5 and 6, for example). In other words, in the touch panel-equipped display device of the present modification example, the drive signals are generated in a manner that prevents small currents from flowing only from the drive electrodes to the sense electrodes via the adhesive applied to the layer in which the drive electrodes and the sense electrodes are formed (that is, only in one direction) over two scanning process periods in the touch panel TP (over the period from time t1 to t3 in FIGS. 5 and 6, for example), and the touch panel TP is driven using the drive signals thus generated. This makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change, which in turn makes it possible to suitably prevent discoloration of the on-cell touch panel in the touch panel-equipped display device according to the present modification example.

### MODIFICATION EXAMPLE 2

Next, Modification Example 1 of Embodiment 2 will be described.

Note that the following description will focus only on aspects that are unique to the present modification example, and detailed descriptions of aspects that are the same as in the embodiment described above will be omitted.

A touch panel-equipped display device according to the present modification example has the same configuration as the touch panel-equipped display device 1000 according to Embodiment 1.

However, in the touch panel-equipped display device of the present modification example, the touch panel TP is driven using drive signals and sense signals that are different from the drive signals and sense signals used in the touch panel-equipped display device 1000 of Embodiment 1.

Next, the operation of the touch panel-equipped display device according to the present modification example will be described.

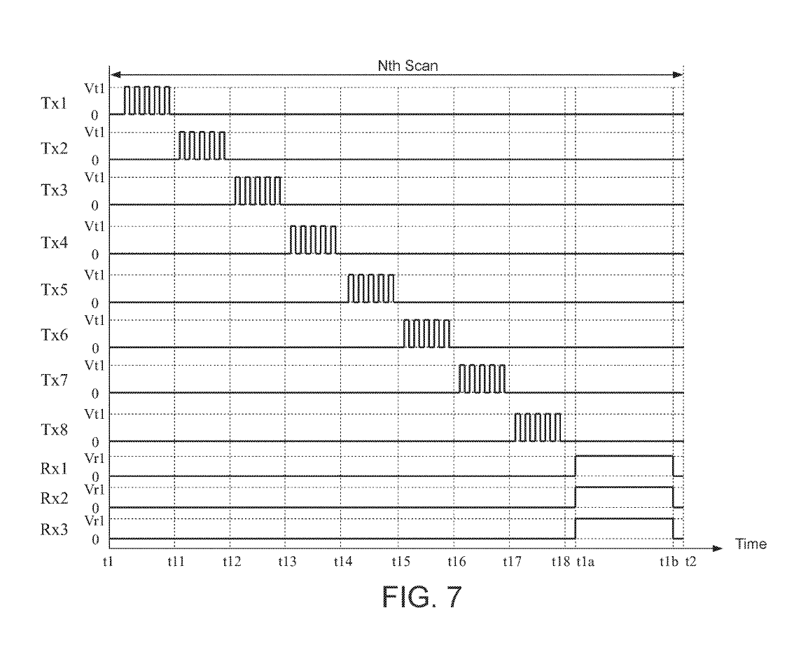

FIG. 7 is a signal waveform diagram illustrating a drive signal Tx1 and a sense signal Rx1 during an Nth (where N is an integer) scanning period (a period from time t1 to t2) in the present modification example.

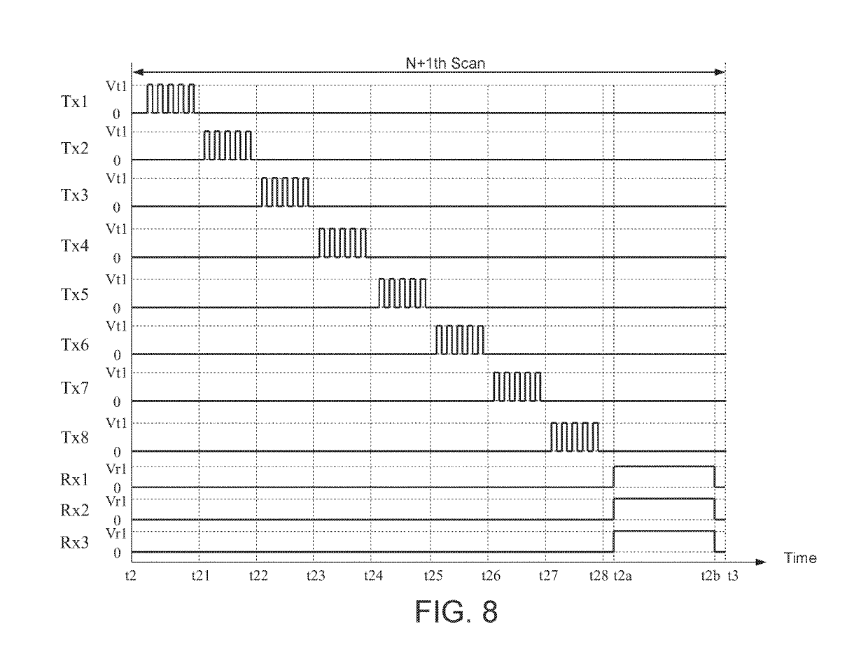

FIG. 8 is a signal waveform diagram illustrating the drive signals Tx1 to Tx8 and the sense signals Rx1 to Rx3 during an (N+1)th scanning period (a period from time t2 to t3).

(Time tl to t11):

During the period from time t1 to t11, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx1 that is output from the transmitter 13 to the drive electrodes Tx11, Tx21, and Tx31 via the drive lines G1gr to G3gr during the period from time t1 to tll is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t1 to t11, the receiver 14 may: (1) apply a bias voltage via the sense lines in order to make the electric potential of the sense electrodes Rx11, Rx21, and Rx31 equal to Vr (where Vr≧0; Vr=1.65V, for example), or (2) not apply a bias voltage in order to ensure the electric potential of the sense electrodes other than the sense electrodes Rx11, Rx21, and Rx31 is equal to 0V.

(Time tll to t12):

During the period from time t11 to t12, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx2 that is output from the transmitter 13 to the drive electrodes Tx12, Tx22, and Tx32 via the drive lines G1gr to G3gr during the period from time t11 to t12 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t11 to t12, the receiver 14 may: (1) apply a bias voltage via the sense lines in order to make the electric potential of the sense electrodes Rx12, Rx22, and Rx32 equal to Vr (where Vr≧0; Vr=1.65V, for example), or (2) not apply a bias voltage in order to ensure the electric potential of the sense electrodes other than the sense electrodes Rx12, Rx22, and Rx32 is equal to 0V.

(Time t12 to t13):

During the period from time t12 to t13, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx3 that is output from the transmitter 13 to the drive electrodes Tx13, Tx23, and Tx33 via the drive lines G1gr to G3gr during the period from time t12 to t13 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t12 to t13, the receiver 14 may: (1) apply a bias voltage via the sense lines in order to make the electric potential of the sense electrodes Rx13, Rx23, and Rx33 equal to Vr (where Vr≧0; Vr=1.65V, for example), or (2) not apply a bias voltage in order to ensure the electric potential of the sense electrodes other than the sense electrodes Rx13, Rx23, and Rx33 is equal to 0V.

(Time t13 to t14):

During the period from time t13 to t14, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx4 that is output from the transmitter 13 to the drive electrodes Tx14, Tx24, and Tx34 via the drive lines G1gr to G3gr during the period from time t13 to t14 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t13 to t14, the receiver 14 may: (1) apply a bias voltage via the sense lines in order to make the electric potential of the sense electrodes Rx14, Rx24, and Rx34 equal to Vr (where Vr≧0; Vr=1.65V, for example), or (2) not apply a bias voltage in order to ensure the electric potential of the sense electrodes other than the sense electrodes Rx14, Rx24, and Rx34 is equal to 0V.

(Time t14 to t15):

During the period from time t14 to t15, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx5 that is output from the transmitter 13 to the drive electrodes Tx15, Tx25, and Tx35 via the drive lines G1gr to G3gr during the period from time t14 to t15 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t14 to t15, the receiver 14 may: (1) apply a bias voltage via the sense lines in order to make the electric potential of the sense electrodes Rx15, Rx25, and Rx35 equal to Vr (where Vr≧0; Vr=1.65V, for example), or (2) not apply a bias voltage in order to ensure the electric potential of the sense electrodes other than the sense electrodes Rx15, Rx25, and Rx35 is equal to 0V.

(Time t15 to t16):

During the period from time t15 to t16, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx6 that is output from the transmitter 13 to the drive electrodes Tx16, Tx26, and Tx36 via the drive lines G1gr to G3gr during the period from time t15 to t16 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t15 to t16, the receiver 14 may: (1) apply a bias voltage via the sense lines in order to make the electric potential of the sense electrodes Rx16, Rx26, and Rx36 equal to Vr (where Vr≧0; Vr=1.65V, for example), or (2) not apply a bias voltage via the sense lines in order to ensure the electric potential of the sense electrodes other than the sense electrodes Rx16, Rx26, and Rx36 is equal to 0V.

(Time t16 to t17):

During the period from time t16 to t17, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx7 that is output from the transmitter 13 to the drive electrodes Tx17, Tx27, and Tx37 via the drive lines G1gr to G3gr during the period from time t16 to t17 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t16 to t17, the receiver 14 may: (1) apply a bias voltage via the sense lines in order to make the electric potential of the sense electrodes Rx17, Rx27, and Rx37 equal to Vr (where Vr≧0; Vr=1.65V, for example), or (2) not apply a bias voltage in order to ensure the electric potential of the sense electrodes other than the sense electrodes Rx17, Rx27, and Rx37 is equal to 0V.

(Time t17 to t18):

During the period from time t17 to t18, the drive controller 12 controls the transmitter 13 in accordance with the control signal from the controller 11. In other words, the drive controller 12 makes the transmitter 13 output the pulse signal illustrated in FIG. 7 via the drive lines G1gr to G3gr. As illustrated in FIG. 7, the drive signal Tx8 that is output from the transmitter 13 to the drive electrodes Tx18, Tx28, and Tx38 via the drive lines G1gr to G3gr during the period from time t17 to t18 is a pulse signal that alternates between signal values (voltages) of 0V and +Vt1 (where Vt1>0; Vt1=10V, for example).

Moreover, during the period from time t1 to t2, in order to ensure that the electric potential of all of the sense electrodes Rx11 to Rx38 is equal to 0V, the receiver 14 does not apply a bias voltage to the sense electrodes.

Alternatively, during the period from time t17 to t18, the receiver 14 may: (1) apply a bias voltage via the sense lines in order to make the electric potential of the sense electrodes Rx18, Rx28, and Rx38 equal to Vr (where Vr≧0; Vr=1.65V, for example), or (2) not apply a bias voltage in order to ensure the electric potential of the sense electrodes other than the sense electrodes Rx18, Rx28, and Rx38 is equal to 0V.

(Time t18 to t1a):

During the period from time t18 to t1a, the drive controller 12 controls the transmitter 13 to not drive any of the drive electrodes Tx11 to Tx38. In other words, in order to make the electric potential of all of the drive electrodes equal to 0V, the drive controller 12 puts the transmitter 13 into a state in which no drive signals are output.

Moreover, as illustrated in FIG. 7, in order to ensure that the electric potential of all of the sense electrodes Rx11 to Rx38 is equal to 0V during the period from time t18 to t1a, no bias voltage is applied to the sense electrodes.

(Time t1a to t1b):

During the period from time t1a to t1b, the drive controller 12 controls the transmitter 13 to not drive any of the drive electrodes Tx11 to Tx38. In other words, in order to make the electric potential of all of the drive electrodes equal to 0V, the drive controller 12 puts the transmitter 13 into a state in which no drive signals are output.

Moreover, as illustrated in FIG. 7, during the period from time t1a to t1b, a bias voltage is applied to the sense line S1gr in order to make the electric potential of all of the sense electrodes Rx11 to Rx38 equal to Vr1 (where Vr1>0; Vr1=10V, for example).

(Time t1b to t2):

During the period from time t1b to t2, the drive controller 12 controls the transmitter 13 to not drive any of the drive electrodes Tx11 to Tx38. In other words, in order to make the electric potential of all of the drive electrodes equal to 0V, the drive controller 12 puts the transmitter 13 into a state in which no drive signals are output.

Moreover, as illustrated in FIG. 7, in order to ensure that the electric potential of all of the sense electrodes Rx11 to Rx38 is equal to 0V during the period from time t1b to t2, no bias voltage is applied to the sense electrodes.

The control process described above constitutes an Nth (where N is an integer) scanning process in the touch panel-equipped display device of the present modification example. The scanning process for the next (N+1)th scanning period (from time t2 to t3) is executed in the same manner as the Nth scanning process. Moreover, the (N+2)th and subsequent scanning processes are also executed in the same manner.

In the touch panel-equipped display device according to the present modification example as described above, implementing the touch panel drive control process described above over a single scanning process period in the touch panel TP (over the period from time t1 to t2 in FIG. 7, for example) results in: (1) an increase in the occurrence of states in which the electric potential of the drive electrodes is greater than the electric potential of the sense electrodes during the period in which the drive electrodes are driven (the period from time t1 to t18 in FIG. 7, for example), and (2) an increase in the occurrence of states in which the electric potential of the drive electrodes is less than the electric potential of the sense electrodes during the period in which the drive electrodes are not driven (the period from time t18 to t2 in FIG. 7, for example).

In other words, in the touch panel-equipped display device of the present modification example, the drive signals are generated in a manner that prevents small currents from flowing only from the drive electrodes to the sense electrodes via the adhesive applied to the layer in which the drive electrodes and the sense electrodes are formed (that is, only in one direction) over a single scanning process period in the touch panel TP (over the period from time t1 to t2 in FIG. 7, for example), and the touch panel drive control process is implemented using the drive signals thus generated. This makes it possible to suitably prevent these small currents that flow between the drive electrodes and the sense electrodes from causing the surfaces of the ITO drive electrodes to deoxidize (due to an oxidation-reduction reaction) and thereby causing the refractive index of the drive electrode portions to change, which in turn makes it possible to suitably prevent discoloration of the on-cell touch panel in the touch panel-equipped display device according to the present modification example.

### Other Embodiments

The embodiment and modification examples described above may be combined in part or in full to implement other configurations of a touch panel-equipped display device or touch panel device.

Moreover, in the embodiment (and modification examples) described above, the touch panel TP of the touch panel-equipped display device included a plurality of drive electrodes and sense electrodes, as illustrated in FIG. 1. However, the touch panel TP is not limited to this configuration. In the touch panel-equipped display device, aspects of the touch panel TP such as the arrangement, number, and shape of the drive electrodes and the sense electrodes may be modified as appropriate. Similarly, aspects of the touch panel TP of the touch panel-equipped display device such as the arrangement of the drive lines and the sense lines are not limited to those presented in the embodiment (or modification examples) described above.

Furthermore, in the embodiment (and modification examples) described above, the drive signals were generated and output so as to sequentially drive the drive electrodes of the touch panel-equipped display device. However, the present invention is not limited to this example, and the drive signals may instead be generated and output so as to drive the drive electrodes simultaneously and in parallel, for example.

For example, the drive signals Tx2 to Tx8 may respectively be output at the same time as the drive signal Tx1 in the touch panel-equipped display device. In other words, in the touch panel-equipped display device, the pulse wave portions of the drive signals Tx1 to Tx8 may all be output during the period from time t1 to tn.

In addition, the touch panel-equipped display device or touch panel device according to the embodiments described above may be implemented in part or in full as an integrated circuit (such as an LSI or a system LSI, for example).

The processes executed by each functional block of the embodiments described above may be implemented in part or in full as programs. Moreover, the processes executed by each functional block of the embodiments described above may be executed in part or in full by a central processing unit (CPU) of a computer. Furthermore, programs for executing these processes may be stored on a storage device such as a hard disk or a ROM, and the central processing unit (CPU) may read and execute these programs from a ROM or a RAM.

In addition, the processes of the embodiments described above may be implemented using hardware or may be implemented as software (including as an operating system (OS), as middleware, or packaged together with prescribed libraries). Moreover, these processes may be implemented using a combination of software and hardware. Moreover, these processes may be implemented using a combination of software and hardware. When the touch panel-equipped display device or touch panel device according to the embodiments described above is implemented using hardware, the timing with which the processes are executed must be controlled. In the embodiments described above, the details of controlling the timing of the various signals that would need to be considered in an actual hardware design were intentionally omitted in order to simplify the description.

Furthermore, the order in which the processes of the embodiments described above are executed is not limited to the order presented in the embodiments as described above, and the execution order may be changed as appropriate within the spirit of the invention.

Both computer-executable computer program implementations of the processes described above as well as computer-readable storage media on which those programs are stored are included within the scope of the present invention. Here, examples of computer-readable storage media that can be used include floppy disks, hard disks, CD-ROMs, MOs, DVDs, high-capacity DVDs, next-generation DVDs, and semiconductor memory.

Such computer programs are not limited to being stored on the abovementioned storage media and may also be transmitted over telecommunications lines, wireless or wired communication routes, networks such as the internet, or the like.

Moreover, the descriptions of the embodiments above were simplified to include only the primary components required for the embodiments to function as described. Therefore, the embodiments may include additional components that are not explicitly mentioned above. Furthermore, in the descriptions and drawings of the embodiments above, the dimensions of the components do not necessarily accurately represent the actual dimensions of those components, the actual dimensional proportions between those components, or the like.

In addition, the specific configuration of the present invention is not limited to those of the embodiments described above, and various modifications or revisions may be made within the spirit of the invention.

<Additional Notes>

The present invention can also be described as follows.

A first invention is a touch panel device that includes a touch panel and a touch panel controller.

In the touch panel, drive electrodes and sense electrodes are formed in the same layer.

The touch panel controller generates drive signals in a manner that keeps an integrated value of differences in electric potential between the drive electrodes and the sense electrodes less than a prescribed value during prescribed periods in which the touch panel is driven.

This makes it possible to generate the drive signals in a manner that prevents small currents from flowing only from the drive electrodes to the sense electrodes via an adhesive or the like that is applied to the layer in which the drive electrodes and the sense electrodes are formed (that is, only in one direction) in the touch panel device. Furthermore, the drive signals thus generated are used to implement a touch panel drive control process in the touch panel device, thereby making it possible to suitably prevent these small currents that flow between the drive electrodes and the sense electrodes from causing the surfaces of the drive electrodes to deoxidize (due to an oxidation-reduction reaction) and thereby causing the refractive index of the drive electrode portions to change. This, in turn, makes it possible to suitably prevent discoloration of touch panels in which the drive electrodes and the sense electrodes are formed in the same layer (such as in on-cell touch panels) in the touch panel device.

Here, it is preferable that the “prescribed value” used to determine the magnitude of the integrated value of the electric potential difference between the drive electrodes and the sense electrodes during the prescribed period be set on the basis of a standard that makes it possible to prevent one-way flow of small currents from the drive electrodes to the sense electrodes during the prescribed period so that the touch panel does not undergo discoloration.

A second invention is the touch panel device according to the first invention, wherein the touch panel controller generates the drive signals so as to include, within a period during which the drive electrodes are driven, a first period in which a signal voltage is a positive voltage and a second period in which the signal voltage is a negative voltage.

This makes it possible to suitably prevent the small currents that flow between the drive electrodes and the sense electrodes from flowing only in one direction during periods in which the drive electrodes are driven in the touch panel device. This, in turn, makes it possible to suitably prevent discoloration of touch panels in which the drive electrodes and the sense electrodes are formed in the same layer (such as in on-cell touch panels) in the touch panel device.

A third invention is the touch panel device according to the first invention, wherein the touch panel controller generates the drive signals so as to include:

(1) within a period during which the drive electrodes are driven in a scanning period T1 of the touch panel, a third period in which a signal voltage is a positive voltage and a fourth period in which an absolute value of the signal voltage is less than or equal to a first threshold value, and

(2) within a period during which the drive electrodes are driven in a next scanning period T2 of the touch panel that occurs after the scanning period T1, a fifth period in which the signal voltage is a negative voltage and a sixth period in which the absolute value of the signal voltage is less than or equal to a second threshold value.

This makes it possible to suitably prevent the small currents that flow between the drive electrodes and the sense electrodes from flowing only in one direction over two scanning periods of the touch panel in the touch panel device. This, in turn, makes it possible to suitably prevent discoloration of touch panels in which the drive electrodes and the sense electrodes are formed in the same layer (such as in on-cell touch panels) in the touch panel device.

Here, it is preferable that the first threshold value be set to a value less than the absolute value of the positive voltage of the drive signals from the third period.

Moreover, during the fourth period, the touch panel controller may generate the drive signals with the signal voltage being equal to 0V.

Furthermore, it is preferable that the second threshold value be set to a value less than the absolute value of the negative voltage of the drive signals from the fifth period.

In addition, during the sixth period, the touch panel controller may generate the drive signals with the signal voltage being equal to 0V.

A fourth invention is the touch panel device according to the first invention, wherein the touch panel controller generates the drive signals:

(1) so as to include, within a period T10 during which the drive electrodes are driven in a scanning period T1 of the touch panel, a third period in which a signal voltage is a positive voltage and a fourth period in which an absolute value of the signal voltage is less than or equal to a third threshold value, and

(2) such that, during a period T11 during which the drive electrodes are not driven in the scanning period T1 of the touch panel, the absolute value of the signal voltage is less than or equal to a fourth threshold value.

In addition, during the period T11 during which the drive electrodes are not driven in the scanning period T1 of the touch panel, the touch panel controller controls an electric potential of the sense electrodes to be positive.

This makes it possible to suitably prevent the small currents that flow between the drive electrodes and the sense electrodes from flowing only in one direction over a single scanning period of the touch panel in the touch panel device. This, in turn, makes it possible to suitably prevent discoloration of touch panels in which the drive electrodes and the sense electrodes are formed in the same layer (such as in on-cell touch panels) in the touch panel device.

Here, it is preferable that the third threshold value be set to a value less than the absolute value of the positive voltage of the drive signals from the third period.

Moreover, during the fourth period, the touch panel controller may generate the drive signals with the signal voltage being equal to 0V.

Furthermore, it is preferable that the fourth threshold value be set to a value less than both the absolute value of the positive voltage of the drive signals from the third period and the absolute value of the positive electric potential of the sense electrodes during the period T11.

In addition, during the period T11, the touch panel controller may generate the drive signals with the signal voltage being equal to 0V.

### INDUSTRIAL APPLICABILITY

The present invention makes it possible to provide a touch panel device that utilizes a touch panel driving process that suitably prevents discoloration of an on-cell touch panel. The present invention can therefore be applied effectively within any industrial sector in which touch panel devices are used.

### DESCRIPTION OF REFERENCE CHARACTERS

1000 touch panel-equipped display device (or touch panel device)

TP touch panel

1 touch panel controller

Tx11 to Tx38 drive electrode

Rx11 to Rx38 sense electrode

1. A touch panel device, comprising:
a touch panel in which drive electrodes and sense electrodes are formed in a same layer; and
a touch panel controller that generates drive signals supplied to the drive electrodes and electric potentials supplied to the sense electrodes such that a relative polarity of an electric potential differential between each drive electrode and the corresponding adjacent sense electrode is reversed at least once during one or more scanning periods of the touch panel so that a time-integrated value of differences in electric potential between each drive electrode and the corresponding adjacent sense electrode over one or more scanning periods in which the touch panel is driven is kept substantially close to zero, thereby preventing the drive electrode from being always biased in one direction relative to the corresponding adjacent sense electrode.

2. The touch panel device according to claim 1, wherein the touch panel controller generates the drive signals so as to include, for each drive electrode, within a period during which the drive electrode is driven, a first period in which a signal voltage supplied to said drive electrode is a positive voltage and a second period in which the signal voltage supplied to said drive electrode is a negative voltage.

3. The touch panel device according to claim 1, wherein the touch panel controller generates the drive signals so as to include, for each drive electrode:
(1) within a period during which the drive electrode is driven in a scanning period T1 of the touch panel, a first period in which a signal voltage supplied to said drive electrode is a positive voltage and a second period in which an absolute value of the signal voltage supplied to said drive electrode is less than or equal to a first threshold value that is lower than an absolute value of said positive voltage, and
(2) within a period during which the drive electrodes is driven in a next scanning period T2 of the touch panel that occurs after the scanning period T1, a third period in which the signal voltage supplied to said drive electrode is a negative voltage and a fourth period in which the absolute value of the signal voltage supplied to said drive electrode is less than or equal to a second threshold value that is lower than an absolute value of said negative voltage.

4. The touch panel device according to claim 1,
wherein the touch panel controller generates the drive signals:
(1) so as to include, for each drive electrode, within a period T10 during which the drive electrode is driven in a scanning period T1 of the touch panel, a second period in which a signal voltage supplied to said drive electrode is a positive voltage and a second period in which an absolute value of the signal voltage supplied to said drive electrode is less than or equal to a first threshold value that is lower than an absolute value of said positive voltage, and
(2) such that, during a period T11 during which said drive electrode is not driven in the scanning period T1 of the touch panel, the absolute value of the signal voltage supplied to said drive electrode is less than or equal to a second threshold value that is lower than an absolute value of said positive voltage, and
wherein, during the period T11 during which said drive electrode is not driven in the scanning period T1 of the touch panel, the touch panel controller controls the electric potential supplied to the corresponding adjacent sense electrode so as to be positive.
